(19) United States
(12) Patent Application Publication
(10) Pub. No.: US 2011/0163236 A1
(43) Pub. Date: Jul. 7, 2011

(54) Scintillation-Cherenkov Detector and Method for High Energy X-Ray Cargo Container Imaging and Industrial Radiography

(75) Inventor: Anatoli Arodzero, Billerica, MA (US)

(73) Assignee: AMERICAN SCIENCE AND ENGINEERING, INC., Billerica, MA (US)

(21) Appl. No.: 12/959,468

(22) Filed: Dec. 3, 2010

Related U.S. Application Data
(60) Provisional application No. 61/267,227, filed on Dec. 7, 2009.
(60) Provisional application No. 61/394,052, filed on Oct. 18, 2010.

(51) Int. Cl. G01T 1/20

(52) U.S. Cl. 250/361 R

(57) ABSTRACT

An inspection system, and corresponding methods, employing a detector for characterizing high energy penetrating radiation transmitted through an inspected object. The detector produces a detector signal that is due to both scintillation and Cherenkov processes. The scintillation and Cherenkov components of the detector signal are discriminated and processed to obtain separate measures of relative attenuation of higher and lower energy penetrating radiation in a target intervening between a source of penetrating radiation and the detector. In certain embodiments of the invention, scintillation and Cherenkov components of a detector signal are discriminated on the basis of distinct spectral features, or, alternatively, by processing temporal characteristics of the signal of a single photodetector.

The present application claims priority based on U.S. Provisional Patent Application Ser. No. 61/267,227, filed Dec. 7, 2009, and on U.S. Provisional Patent Application Ser. No. 61/394,052, filed Oct. 18, 2010, both of which applications are incorporated herein by reference.

### TECHNICAL FIELD

The present invention relates to systems and methods for detecting high-energy penetrating radiation, particularly, for application in the inspection of objects with such radiation.

### BACKGROUND ART

X-ray security inspection systems for cargo and shipping containers typically use transmission radiographic techniques with a fan-shaped beam to produce images of a target object. One example of a cargo inspection system employing transmission imaging is provided by the MobileSearch™ HE product manufactured by American Science and Engineering, Inc.

In cargo imaging applications, it may be necessary for penetrating radiation to penetrate a significant thickness of highly attenuating material, and a requirement for penetration of more than 300 mm of steel equivalent is not unusual. As used herein, a penetration depth quoted in length of steel equivalent refers to the maximum steel thickness behind which a lead block can still be seen. For thicknesses of steel exceeding the penetration capacity of a particular imaging system, the image will be completely dark, and the block will not be seen.

To ensure the required penetration, inspection systems employed for the inspection of cargo, and in certain industrial applications may typically use X-rays with a maximum energy of several MeV, and, more particularly, in current systems, energies up to about 9 MeV. As used herein and in any appended claims, energies in excess of 1 MeV may be referred to as hard X-rays or high energy X-rays.

A transmission imaging system, designated generally by numeral 1 in FIG. 1A, employs one or more sources 6 of penetrating radiation, such as X-rays. High energy X-rays are typically produced by means of a linear accelerator (linac). The detectors for high energy inspection systems should respond to a wide range of input X-ray signal intensities to correlate with a wide range of attenuation paths encountered by the X-ray beam. For example, a container of food products provides a uniform, high-attenuation X-ray path. A container that is almost empty, loosely packed, or containing irregular objects, will have some very low attenuation paths through empty spaces. The detection system should handle this wide range of paths whose attenuations may differ by more than a factor of 100,000.

One type of detector for such systems typically uses of an array of detector elements with each element consisting of a scintillator crystal and a photodetector. In FIG. 1A, detector elements 8 and 12 are shown, by way of example, from among an array of detector elements disposed along a gantry 4. Insofar as imaging resolution is governed by detector element dimensions, each element may be referred to herein as a “pixel.” Particles in beam 2 of penetrating radiation emitted by source 6 may be referred to, herein, as X-rays, for heuristic convenience. X-rays in beam 2 traverse inspected target 7, which may be a cargo container, or vehicle, for example, and an object 3, contained therein, is irradiated by the beam. X-rays that traverse target 7 are incident on detector 12, while some X-rays 5 may be scattered indirectly into detector 12.

In many applications, scintillation detectors operate in a current integrating mode, and individual photon detections are not resolved. When operating in a current integrating mode, scintillation detectors do not provide any information about the energy spectra of the X-rays which reach the detectors after penetrating through the inspected target. Therefore, low energy radiation scattered from the target object can introduce parasitic background noise into the detector signal, thereby reducing image contrast.

Another type of detector employed in the detection of penetrating radiation utilizes the Cherenkov effect, which occurs if the energy of the electrons and positrons generated in the detector medium is above the Cherenkov threshold, which is to say that they travel through the medium at a speed exceeding the speed of light in the same medium. (In this context, the detecting medium may be referred to, herein, as the “radiator,” in that it radiates Cherenkov emission.) Energetic charged species are created by photons incident on the detector medium either by electron recoil in a Compton scattering interaction or by pair production, and, in either case, may be referred to, herein, as “kinetic electrons,” reflecting the fact that they are no longer bound to atoms in the medium.

Cherenkov detectors generally operate in the photon counting mode. The signal from the detector (possibly shaped by associated pulse-shaping electronics) is substantially proportional to the energy of the X-ray photon, if the energy of the photon is more than 2 to 3 times higher than the threshold energy, and under flux conditions in which energy resolution is not confusion-limited.

Cherenkov detectors, however, are not effective for inspection of parts of a container or industrial component that are characterized by low density or low atomic number (low-Z) materials. Such materials are best inspected by the low energy photons in the X-ray spectrum, but these photons are at energies that fall below the Cherenkov threshold and do not produce Cherenkov radiation. Moreover, these low energy photons can produce parasitic luminescence (scintillation) in the radiator. The spectrum of this luminescence overlaps with the Cherenkov spectrum and can be much more intense. Cherenkov radiators that use low luminescence material are more expensive than Cherenkov radiators not optimized to reduce luminescence.

The use of Cherenkov detection in the context of cargo inspection is discussed in U.S. Pat. No. 7,453,987 (to Richardson), which is incorporated herein by reference.

The only context in which scintillation and Cherenkov radiation have been used together is that of dual-readout calorimetry applied in characterizing sub-atomic particles such as electrons or pions in high-energy research. Such application has been described by Akchurin et al., Dual-readout calorimetry with lead tungstate crystals, Nucl. Instr. And Methods in Physics Research, vol. 584, pp. 273-84 (2008), which is incorporated herein by reference.

Thus, in the current art of material characterization, Cherenkov detection and scintillation detection are always practiced separately and to the exclusion of each other.

Conversely, in applications such as medical dosimetry, where it is essential to obtain quantitative scintillation measurements, Cherenkov emission is considered confounding, and methods are taught in the art to ensure that measurements are free of Cherenkov contamination. Such teaching may be found, for example, in Clift et al., Dealing With Cerenkov Radiation Generated In Organic Scintillator Dosimeters By Bremsstrahlung Beams, Phys. Med. Biol., vol. 45, pp. 1165-82 (2000), which is incorporated herein by reference.

### SUMMARY OF EMBODIMENTS OF THE INVENTION

In accordance with embodiments of the present invention, a system is provided for characterizing material composition of an object. The system has a source of penetrating radiation for generating a beam of penetrating radiation incident upon the object. The system also has at least one detector for generating a scintillation detector signal component and a Cherenkov detector signal component based respectively upon a scintillation process and a Cherenkov radiation processes initiated by penetrating radiation that has traversed the object. Finally, the system has a processor for deriving relative attenuation of higher and lower energy penetrating radiation in the object, disposed between the source of penetrating radiation and the at least one detector, based on the scintillation detector signal component and the Cherenkov detector signal component.

In accordance with further embodiments of the present invention, the system for characterizing material composition of an object may, in particular, have one, and only one, detector per pixel element. The system may also have a signal conditioning module of a kind that discriminates between the scintillation detection component and the Cherenkov detector signal component to produce a scintillation detector signal channel and a Cherenkov detector signal channel, based on spectral or temporal features of the scintillation process and the Cherenkov radiation process.

In accordance with other embodiments of the present invention, a detector is provided for detecting and characterizing high energy penetrating radiation. The detector has a detecting medium for generating kinetic charged particles and, in response thereto, emitting electromagnetic radiation. Additionally, the detector has at least one photodetector for detecting electromagnetic radiation emitted by the detecting medium through a Cherenkov radiation process and through a scintillation process, and a signal conditioning module, coupled to the at least one photodetector, for discriminating detector signal components due respectively to Cherenkov and scintillation processes.

The detector may have a signal conditioning module of a kind that discriminates between components due respectively to Cherenkov and scintillation processes on the basis of spectral features of the scintillation process and the Cherenkov radiation process. Alternatively, the signal conditioning module may be of a kind that discriminates between components due respectively to Cherenkov and scintillation processes on the basis of temporal features of the scintillation process and the Cherenkov radiation process.

In accordance with further embodiments of the invention, the detector may have only a single photodetector. The signal conditioning module, in that case, may be of a kind that discriminates between a scintillation component and a Cherenkov component of the detector signal on the basis of distinct respective time signatures of the scintillation component and the Cherenkov component. The signal conditioning module may distinguish between a high temporal frequency component associated with the Cherenkov component of the detector signal and a low temporal frequency component associated with the scintillation component of the detector signal. It may, in response to a pulse of radiation, extrapolate a temporal tail of the detector signal that persists after the pulse, to derive a scintillation component of the detector signal during the pulse. It may subtract a scintillation component of the detector signal during the pulse of radiation from a total measured detector signal during the pulse to derive a Cherenkov component of the detector signal during the pulse.

Alternatively, the detector may have more than one photodetector, such as a first photodetector for detecting electromagnetic radiation emitted by the detecting medium through a Cherenkov radiation process and a separate, second photodetector for detecting electromagnetic radiation emitted by the detecting medium through a scintillation process. There may be a first photodetector signal conditioning module for receiving a first detector signal associated with the first photodetector and a second photodetector signal conditioning module for receiving a second detector signal associated with the second photodetector. The first signal conditioning module includes a photon-counting electronics module, and the second signal conditioning module includes a current-integrating electronics module. The first signal conditioning module may also include a gated amplifier for amplifying a signal during a specified duration of time in synchrony with emission of penetrating radiation by the source.

In yet further embodiments of the present invention, a system is provided for chacterizing material composition of an object, in accordance with claim 1, wherein the detector may be of any of the sorts of detectors described above.

In accordance with alternate embodiments of the invention, methods are provided for characterizing an object intervening between a source of penetrating radiation and a detector. These methods have steps of:
a. detecting electromagnetic radiation emitted by a detecting medium through a Cherenkov radiation process and through a scintillation process;
b. discriminating detector signal components due respectively to Cherenkov and scintillation processes; and
c. deriving relative attenuation of higher- and lower-energy penetrating radiation in the target based on the detector signal components due respectively to Cherenkov and scintillation processes.

In other embodiments of the invention, time-varying spectral content of the source of penetrating radiation may be employed to obtain Cherenkov and scintillation components at distinct energy levels.

More particularly, the detecting medium may constitute a single detector. Light measured after termination of a beam pulse provided by the source of penetrating radiation is employed to derive detector signal components due respectively to Cherenkov and scintillation processes.

### BRIEF DESCRIPTION OF THE DRAWINGS

The foregoing features of the invention will be more readily understood by reference to the following detailed description, taken with reference to the accompanying drawings, in which:

FIG. 1A is a schematic view of a prior art high-energy x-ray cargo inspection system to which features of the present invention may be advantageously applied;

FIG. 1B schematically illustrates a scintillation-Cherenkov detector for high energy X-rays employing a single medium and optical spectral separation of scintillation and Cherenkov light, in accordance with an embodiment of the present invention;

FIG. 2 depicts spectral separation of scintillation and Cherenkov light arising in a single detection medium, in accordance with embodiments of the present invention;

FIG. 3 shows the temporal profile of scintillation light and Cherenkov light obtained in a detector of X-ray bremsstrahlung pulses with end-point energy 6.0 MeV (higher energy) and 3.5 MeV (lower energy) that have been transmitted through an iron absorber;

FIG. 4 plots the measured ratio of the higher-energy to lower-energy signal versus thickness of an iron absorber, in Cherenkov and scintillation channels, respectively, in accordance with an embodiment of the present invention;

FIG. 5 illustrates the material discrimination capability of embodiments of the present invention, plotting the ratio of higher-energy signal to lower-energy signal in respective scintillation and Cherenkov channels as a function of object thickness for various materials;

FIG. 6 is a schematic depiction of a single scintillation-Cherenkov detector in accordance with an embodiment of the present invention;

FIG. 7 depicts a method for extracting respective Cherenkov and scintillation components of a single photodetector signal, in accordance with an embodiment of the present invention;

FIG. 8 plots the initial 325 ns of a scintillation-Cherenkov light pulse, as detected by a single photodetector, in accordance with the present invention;

FIG. 9 plots the dependence of the respective Cherenkov and scintillation components of the intensity of a single X-ray pulse detector signal, in accordance with an embodiment of the present invention; and

FIG. 10 plots the relative intensities of the Cherenkov and scintillation components of a detector signal, in accordance with an embodiment of the present invention.

### DETAILED DESCRIPTION OF EMBODIMENTS OF THE INVENTION

### Definitions

As used herein, when the terms “high” and “low” are used in conjunction with one another, they are to be understood in relation to one another. Thus, “low energy”, or “lower energy” refers to radiation which is characterized by a lower endpoint energy than radiation which is characterized as “high energy” or “higher energy.” When used alone, the term “high energy” refers to radiation characterized by an endpoint energy in excess of 1 MeV per particle.

In accordance with preferred embodiments of the present invention, detector signals that are derived separately from scintillation and Cherenkov detection processes are used to enhance imaging over the entire range of attenuation that is expected in cargo. For example, scintillation may be used dominantly in lower attenuation of regions of the cargo, where in-scatter is not a limiting factor. In high-attenuation regions, where penetration is essential and sensitivity is limited by in-scatter, a Cherenkov signal may be used preferentially filter out the in-scatter. Combination of multi-energy inspection and joint scintillation and Cherenkov detection advantageously sorts materials by effective atomic number, as described below.

In particularly preferred embodiments of the present invention, a single detector is provided that may be operated in a mode that is free from drawbacks mentioned in the Background section. The X-ray detector disclosed herein utilizes both the scintillation light and the Cherenkov radiation produced by the X-ray in the same scintillation medium. Additionally, apparatus and methods for employing such detection mechanisms in the inspection of cargo and other industrial applications are taught herein.

A typical scintillator detector consists of a volume of a light-transparent scintillation medium optically coupled to one or more photodetectors, each, usually a photomultiplier tube or a solid state photodetector. If the energy of the X-ray is small, the photodetector signal which arises from the scintillation mechanism is typically proportional to the energy of the electron(s) generated in the medium by the photoelectric and/or Compton effect. Conversion of the energy of the incident X-ray to visible light may occur through multiple scattering processes, with a significant fraction (the conversion efficiency) of the energy ultimately converted and detected by one or more photodetectors.

Cherenkov radiation occurs when the electrons have energy above the Cherenkov threshold, which is to say that the electrons pass through a detector medium (any optically transparent medium, including scintillators) faster than light travels in that medium. This Cherenkov emission threshold condition is given by

nβ>1, (1)

where n is the refractive index of the detector medium, and β is the ratio of the electron velocity ν to the speed of light in a vacuum c. The fundamentals of Cherenkov radiation and its application may be found in V. P. Zrelov, Cherenkov Radiation in High-Energy Physics, (Jerusalem: Israel Program for Scientific Translation, 1970), which is incorporated herein by reference.

For sufficiently energetic X-rays the energy of the generated electrons can achieve the aforementioned threshold condition. The corresponding Cherenkov threshold energy Eₜₕ for the electron can be written

$${E}_{th} = {m}_{0} {c}^{2} ( - 1 + \sqrt{1 + \frac{1}{{n}^{2} - 1}} ) , \qquad ( 2 )$$

where m₀c² represents the electron rest-mass energy, 0.511 MeV.

In a transparent isotropic medium the number of Cherenkov photons emitted per unit electron path length x within a unit spectral range is given by the Tamm-Frank formula

$$\frac{{d}^{2} {N}^{ph}}{d x d λ} = \frac{2 πα}{{λ}^{2}} [ 1 - {β}^{- 2} ( E ) {n}^{- 2} ( λ ) ] , \qquad ( 3 )$$

where α is the fine structure constant= 1/137 and λ is the wavelength of the Cherenkov light. The dependence n(λ) is well described by the Cauchy formula

n(λ)=A+B/λ², (4)

where A and B are constants characterizing the medium. The dependence β(E) is determined by the relativistic expression for velocity (in units of c, the vacuum speed of light), and can be written as

$${β}^{2} ( E ) = \frac{E ( E + 2 {mc}^{2} )}{{( E + {mc}^{2} )}^{2}} . \qquad ( 5 )$$

The total number of photons within the spectral range (λ₁, λ₂) emitted during the deceleration of an electron with energy E is determined by the integral

$${N}^{ph} ( {λ}_{1} , {λ}_{2} ) = {\int }_{{λ}_{1}}^{{λ}_{2}} d λ {\int }_{{E}_{0} ( λ )}^{E} d {E}^{′} \frac{{d}^{2} {N}^{ph}}{d x d λ} {( \frac{d {E}^{′}}{d x} )}^{- 1} , \qquad ( 6 )$$

where E₀(λ) is the threshold energy of Cherenkov radiation.

Cherenkov radiation is the electromagnetic “shock-wave” of light generated by a relativistic charged particle travelling beyond the speed of light in the medium. The photons of Cherenkov radiation have a continuous spectrum from the ultraviolet to the infrared, with intensity proportional to λ⁻². Therefore, Cherenkov radiation is stronger in the UV and the violet region of the visible spectrum than in the infrared. The duration of Cherenkov radiation in detectors is very short; typically a few hundred picoseconds.

For detectors designed for X-rays in the MeV region, the “effective Cherenkov threshold energy” is higher than the threshold indicated by Eqn. (2) due to losses of light in the radiator, and the limited light collection and quantum efficiency of the photodetector. In practice, the effective threshold energy can be between 1 and 3 MeV, dependent on the detector configuration and the properties of the medium.

In contrast with Cherenkov radiation, the scintillation mechanism is a process of light generation by a moving charged particle exciting the medium. Typical scintillators generate light in the visible region. The duration of the light is dominated by the exponential decay of the scintillation with decay times from tens to thousands of nanoseconds.

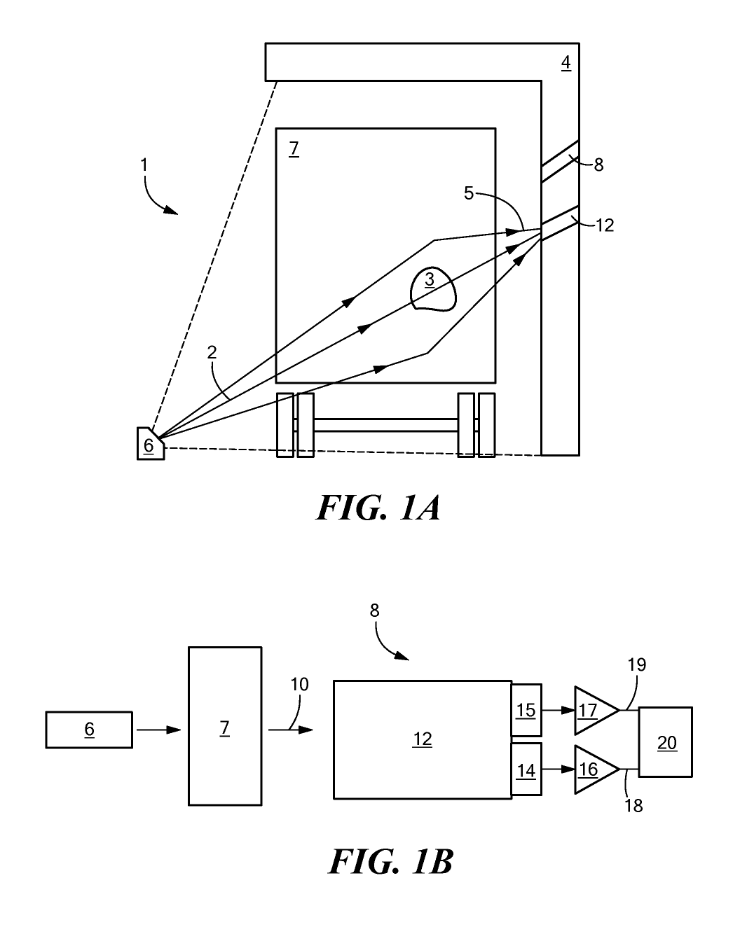

In accordance with preferred embodiments of the present invention, both the scintillation and the Cerenkov light produced by an X-ray may be measured independently in the same medium, as now described with reference to FIG. 1B, which shows an X-ray detector, designated generally, and in its entirety, by the numeral 8. While the scintillation light is proportional to the total energy deposited by the X-ray-generated electrons and positrons, Cherenkov light is produced only by electrons and positrons with energy above the Cherenkov threshold.

Photons in X-ray beam 10 incident on a single detector medium 12 give rise to energetic electrons (not shown) in the medium and, thus, to photons (in the infrared through ultraviolet (UV)) arising due to scintillation and (where the electrons are sufficiently energetic) Cherenkov processes. X-rays are produced by source 6, which may be a linac, for example, and traverse a target 7, which may be a cargo container undergoing security inspection, for example. While source 6 is preferably pulsed, as a linac or betatron, source 6 may also be a continuum source, such as a Rhodotron, within the scope of the present invention.

Source 6 may provide pulses of distinct energy spectra. The effective endpoint energy (and, thus, highest X-ray energy in the Bremsstrahlung spectrum) may be varied from pulse to pulse. Alternatively, a time-dependence of the endpoint energy during the course of a single pulse may be used to obtain high-energy and low-energy components of a detected pulse, during the course of each individual pulse. More particularly, the number of energy components that may be derived during the energy buildup within a pulse is not limited. Three or more separated energies may be sorted from a single pulse, within the scope of the present invention. Good material discrimination may be obtained over most of the periodic table if three energies are used, and the highest energy is in the 7.5-8 MeV range.

Detector medium 12 is chosen, using design criteria known in the art, from among any materials now known, or discovered in the future, to be useful for such detection purposes. These may include optically transparent media such as glasses, plastics, etc., or crystals of alkali halides, bismuth germanate (BGO), often respectively doped with suitably high-cross-section dopants, such as rare earth oxides or sulfates, organic scintillators, etc., known to enhance scintillation. Common scintillators include bismuth germanate (BGO), lead fluoride (PbF₂), lead tungstate (PbWO₄, or “PWO”), all provided here, as examples, without limitation. One or more photodetectors 14 and 15 are provided to detect emission, in appropriate portions of the electromagnetic spectrum, indicating processes that convert the kinetic energy of charged particles into light. The use of a single photodetector is expanded upon, below.

Photodetectors 14 and 15 (if more than one photodetector are present) may be the same or different, within the scope of the present invention, and, where different, typically have distinct spectral response. Indeed, filters (not shown) may be provided to enhance the spectral distinction between the spectral responses of the two photodetectors. The light-collecting geometries of the respective photodetectors 14 and 15, if more than one is used, may be optimized to distinguish between Cherenkov radiation and scintillation according to known optical design procedures.

The electrical signal output of each photodetector 14 is coupled to one or more signal conditioning modules 16. Signal conditioning module 16 may be a photon-counting mode electronics module, generating an output signal in a first channel 18 proportional to the number of X-ray photons detected in detector medium 12 with energy exceeding the actual Cherenkov threshold. The electrical signal output of photodetector 15, in turn, may be coupled to a second signal conditioning module 17, which may be a current-integrating and/or photon-counting mode electronics module, producing a signal in a second channel 19 that is proportional to the total X-ray energy deposited in the scintillator. First and second channels 18 and 19 are input to processor 20 for processing as further discussed below. Photon counting is not preferred as a signal processing modality in applications where flux requirements and source micropulse durations preclude separate detection of distinct x-ray photons.

The photons with energy above the Cherenkov threshold are most likely photons that have passed through the inspected object without interaction, i.e. they are not scattered photons, since scattered photons, having lost energy on scattering, are more likely to have been scattered to energies below the Cherenkov threshold. The ratio of the signals from both channels is a measure the high energy fraction of the X-ray spectrum which penetrates the object. The technique can discriminate against low energy photons, which consist at least in part of scattered radiation, and thus eliminate their contribution to the image so that the contrast is increased. Furthermore, this can be done with reduced incident dose.

As discussed above, the difference in the mechanisms of light generation between scintillation and Cherenkov radiation results in the duration of the Cherenkov light pulse being at least one order of magnitude shorter than the duration of scintillation light, as evident from inspection of FIG. 7, which is discussed below, and where respective pulses of scintillation and Cherenkov light are plotted on the same time scale.

In accordance with one class of embodiments of the present invention, a detector signal due to scintillation may be discriminated from a detector signal due to Cherenkov radiation on the basis of the respective spectral signatures of the two light-emitting modalities. In this class of embodiments, detector 8 contains two independent photodetectors 14 and 15. Only a small fraction of the scintillation light contributes to the Cherenkov channel output signal since it is counting individual photon detection events for photons exceeding the Cherenkov threshold.

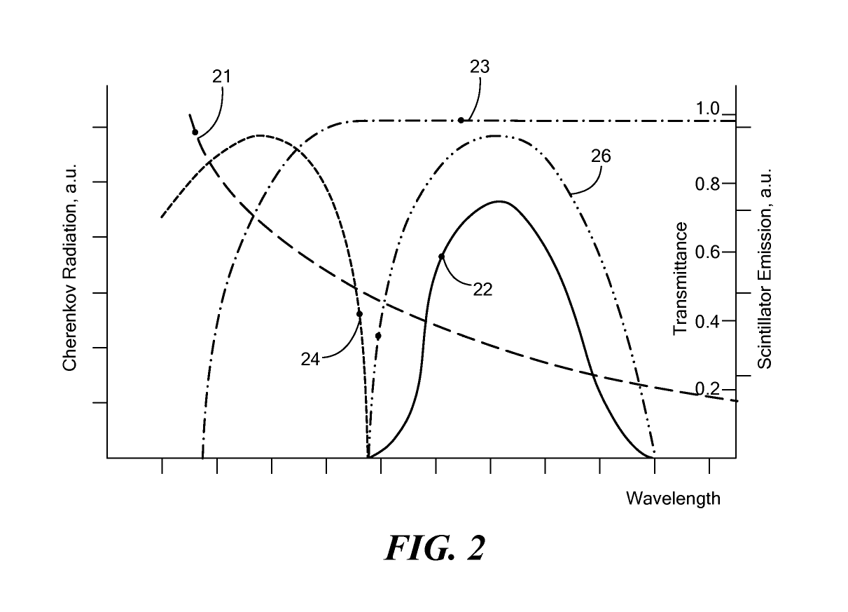

As shown in FIG. 2, Cherenkov radiation exhibits a λ⁻² spectrum 21, most intense in the UV and violet region of the visible spectrum. In contrast, many scintillators emit light in the green and red regions of the spectrum, as shown by curve 22. Curve 23 depicts typical transmittance of the scintillator medium. Curves 24 and 26 are transmission curves, respectively, of a shortpass violet/UV filter (24, such as a UG11 filter) used to define a Cherenkov channel and a bandpass filter (26, such as a GG400 filter) used to define a scintillation channel. This permits the separation of Cherenkov and scintillation light by spectral filtration of the light.

Another modality for separating Cherenkov and scintillation light uses a scintillator, such as CsI, with scintillation emission peaked in the UV or violet regions. In that case, longer-wavelength photons are preferentially due to Cherenkov emission, thereby, again, providing for separation of Cherenkov and scintillation light by spectral filtration of the light.

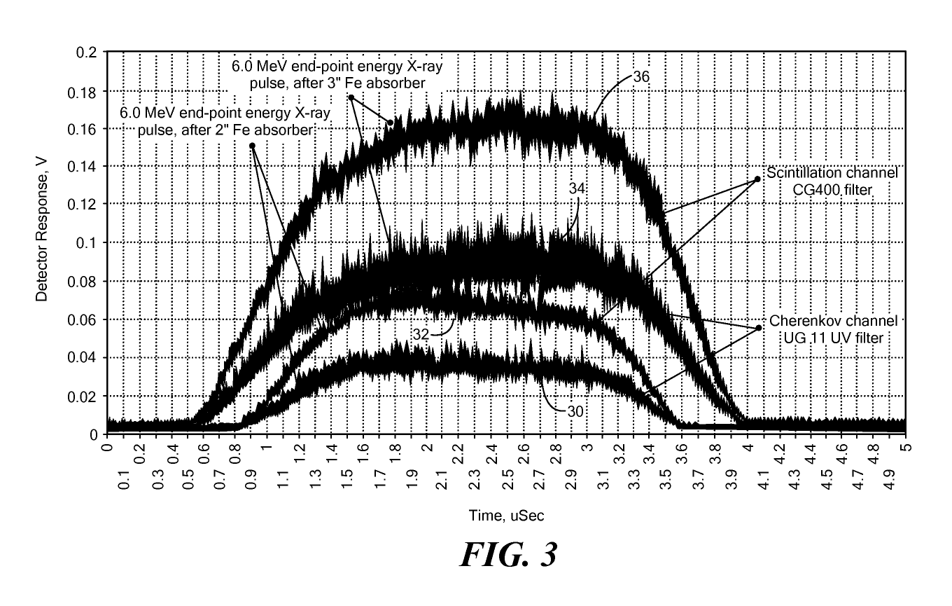

Once scintillation and Cherenkov signal components have been separated, as discussed above, or using techniques discussed below, the separated signal components may be used in the context of material inspection as now discussed. These techniques have been used, by way of example, to measure the temporal response of the scintillation light and the Cherenkov light produced in a PbWO₄:Mo scintillation-Cherenkov detector. The spectra obtained in a single linac pulse is shown in FIG. 3 for x-ray beams of 6 MeV and 3.5 MeV that have traversed an iron absorber. Spikes apparent in X-ray pulses are generated by individual X-ray photons. Upper curve 36 is the signal (as a function of time) of a high-energy (6 MeV) pulse in the Cherenkov channel, while curve 34 corresponds to the same pulse in the Cherenkov channel. Curves 32 and 30 are low-energy (3.5 MeV) pulses in scintillation and Cherenkov channels, respectively.

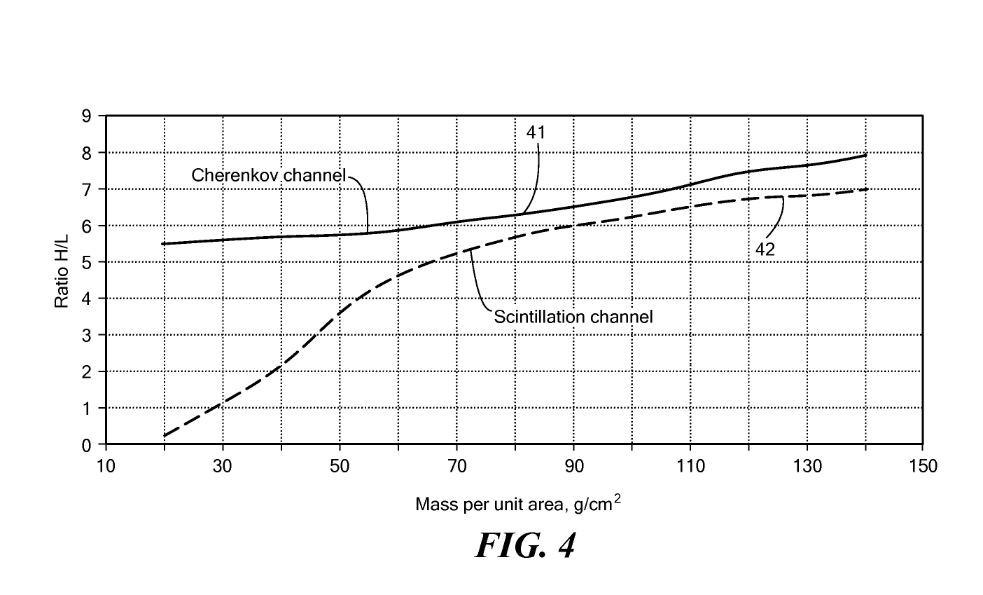

FIG. 4 shows a measured ratio of higher energy signal (6.0 MeV) over lower energy signal (3.5 MeV) vs. thickness of iron absorber. The data was taken using PbWO₄:Mo detector with spectral optical filtration in scintillation and Cherenkov channels, as described above. In contrast to the Cherenkov signal plotted versus absorption length in curve 41, the scintillation signal 42 demonstrates sensitivity to the low energy part of transmitted X-ray spectrum in that its slope versus column length is steeper in low absorption areas. These features of a Scintillation-Cherenkov detection approach, in accordance with the present invention, may be used advantageously to eliminate negative effects of in-scatter radiation in high energy X-ray inspection systems.

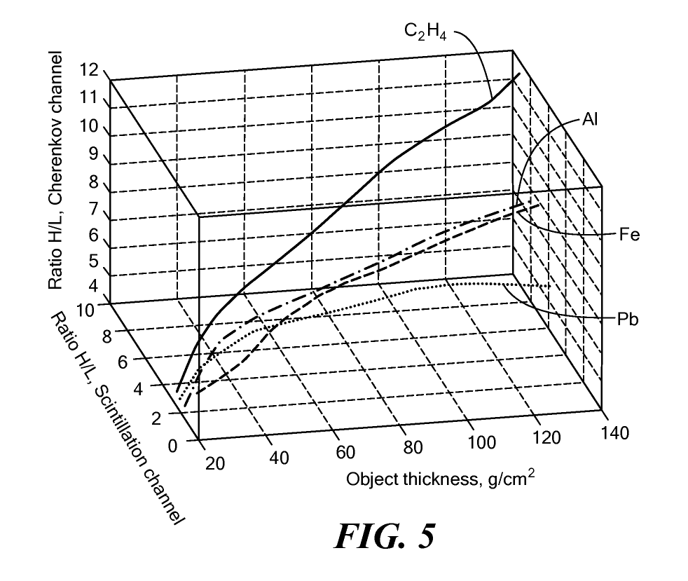

Capabilities afforded by embodiments of the present invention to discriminate among materials of distinct effective atomic number are depicted in FIG. 5. Plots are shown of the ratio of a higher-energy (6 MeV) to a lower-energy (3.5 MeV) signal in a scintillation channel (Y axis) and a Cherenkov channel (Z axis) as a function of material thicknesses of four materials: polyethylene, aluminum, iron, and lead.

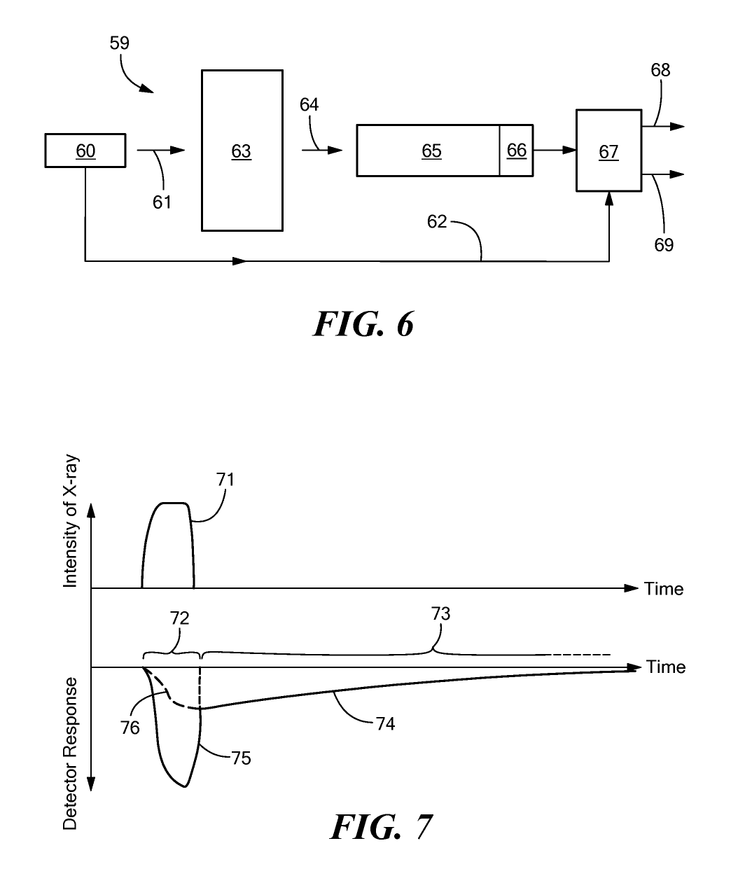

Other embodiments of the invention, described with reference to FIG. 6, may be employed when the X-ray source 60 is pulsed, such as when a linac serves as the source. A scintillation-Cherenkov system, designated generally by numeral 59, is shown that uses a single scintillation element 65 and a single photodetector 66. A synchronization signal 62 from the source 60 is used to trigger time gates in signal conditioning module 67, which generates Cherenkov and scintillation channel signals 68 and 69. A short time gate is used in the Cherenkov channel 68, and a delayed, long duration gate is used in the scintillation channel 69, as depicted in the timing plot of FIG. 7, described below.

On the upper time axis of FIG. 7, curve 71 depicts the duration, several microseconds in length, of the X-ray pulse. On the lower time axis, curve 74 shows the portion of the photodetector intensity due to scintillation, while curve 75 shows the Cherenkov portion of the photodetector intensity. The Cherenkov signal is typically integrated during interval 72, while the signal integrated during interval 73, after X-ray pulse 71 has ended, and before the next pulse, is entirely due to the scintillation tail. The area under portion 76 of the scintillation response curve 74 may be considered a “contamination” of the Cherenkov pulse, and may be treated as described below.

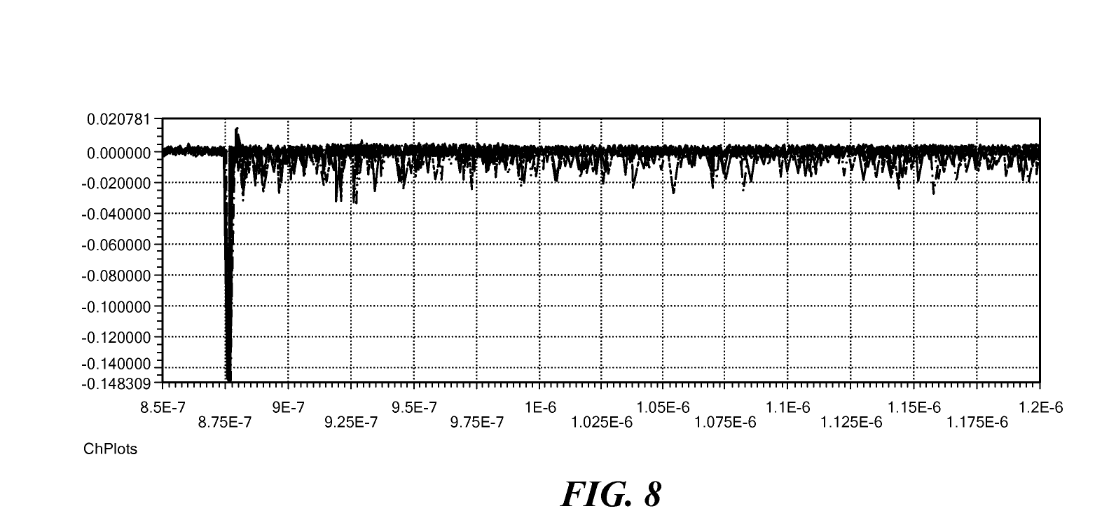

FIG. 8 shows the first 325 ns of a scintillation-Cherenkov light pulse generated by 5.5 MeV monochromatic X-ray single photons in a ZnWO₄ detector, showing 103 individual detection events. The scintillation decay time for ZnWO₄ is 22 μs.

In yet further embodiments of the present invention, both time-gating and spectral separation may be used to distinguish between Cherenkov radiation and scintillation light in order to discriminate between high-energy and low-energy photons.

Single-photodetector embodiments. In accordance with certain embodiments of the present invention, illustrated schematically in FIG. 6, both the intensity of the scintillation light and the intensity of Cherenkov light emitted within a single scintillator volume during the course of each pulse of a pulsed X-ray beam may be derived using only a single photodetector. These embodiments are preferred since only one detector is needed, and the electronics for finding edges on the nanosecond time scale are available.

When a single photodetector is used, temporal discrimination is employed to separate scintillation and Cherenkov channels. The scintillator material is characterized by a decay time, τ, that is long compared to the width, T, of the X-ray beam pulse, but is short compared to the time between beam pulses. By separately measuring the light intensity emitted during the time T and the light intensity emitted after T, one obtains the total intensity of scintillation light and the total intensity of Cherenkov light produced in the detector by the X-ray beam pulse. Any algorithm employed for temporally discriminating between the Cherenkov and scintillator contributions to the detected intensity are within the scope of the present invention.

The total intensity of light I(T) emitted during the beam pulse T, consists of scintillation light I_{S}(T) plus Cherenkov light I_{Ch}(T); that is, I(T)=I_{S}(T)+I_{Ch}(T). The Cherenkov light ceases at time T since there are no longer ionizing particles in the detector. The scintillation light, however, continues to be emitted for 3τ (95% of the light), that is, long after the X-ray beam pulse has ended.

The decay characteristics of the scintillation light from a particular scintillating medium are known and stable. Therefore, the scintillation light, I_{S}(>T), emitted after time T can be extrapolated back to T=0 to give a direct measure of the total scintillation intensity I_{S}, as well as the scintillation intensity I_{S}(T) emitted during the beam pulse. Subtracting I_{S}(T) from I(T) yields the intensity of the Cherenkov light I_{Ch}(T), which is the total Cherenkov signal I_{Ch}.

Thus, the measurements of intensities during the two time intervals, 0≦t≦T and t≧T, yield the total Cherenkov intensity and the total scintillation intensity. With the proper design of the scintillator size and shape, the former intensity can be a good measure of the high-energy component of the X-ray beam pulse, while the latter intensity can be a good measure of the low-energy component of the X-ray beam pulse. As is well known in the art, the two measurements together yield information of the atomic number of the material traversed by the X-ray beam prior to entering the detector.

The method for discrimination of scintillation and Cherenkov components of a single detector signal is illustrated for a 6 MeV linear accelerator that produces X-rays beams in pulses of 3.5 μs duration separated by 3 ms. A preferred material is ZnWO₄ that scintillates at a peak wavelength of 480 nm and has a decay time of 22 μs, which is ˜7 times greater than the linac pulse width and 150 times shorter than the time between pulses. Another candidate is the well-known scintillator CdWO₄ whose scintillation light has two major components: a 60% component, peaking at 540 nm, with a decay time of 14 μs, and a 40% component, peaking at 470 nm, with a decay time of 5 μs. The Cherenkov and scintillation light is collected by a photomultiplier, preferably chosen and coupled to the scintillator in such a manner that the Cherenkov intensity (mainly in the wave lengths below 400 nm) and the scintillation intensity, typically above 400 nm, are roughly balanced. The balance can be controlled by, for example, choosing a photodetector whose light collection efficiency favors the Cherenkov intensity and/or inserting an appropriate filter of the scintillation component.

The time dependences of the scintillation signal and the Cherenkov signal, as well as their sum (i.e. the measured signal), is simply described for the ideal case in which the X-ray spectrum traversing the detector does not change over the time interval T of the X-ray pulse. In that case, the Cherenkov signal has a constant mean value over the interval T, and is zero after the X-ray pulse ends.

The scintillation pulse for the idealized case has the simple time dependence of Eq. 7a during the X-ray pulse, and the simple time dependence of Eq. 7b after the pulse.

I_{Sc}(t≦T)=I(Eₑ,Iₑ,eff,t)×(1−e^{-t/τ}) (7a)

I_{Sc}(t≧T)=I_{Sc}(t=T)×e^{-t/τ} (7b)

The quantity I(Eₑ, Iₑ, eff, t) is a constant in the ideal case of this example. It is written to indicate that the method works even though the electron energy, Eₑ, and/or the electron current, Iₑ, of the pulsed accelerator may be functions of the time t during the course of the pulse. The only requirement is one that is generally true, namely, that the time dependences be the same from pulse to pulse. Once measured, they can be used in the general expressions of Eqs. 7.

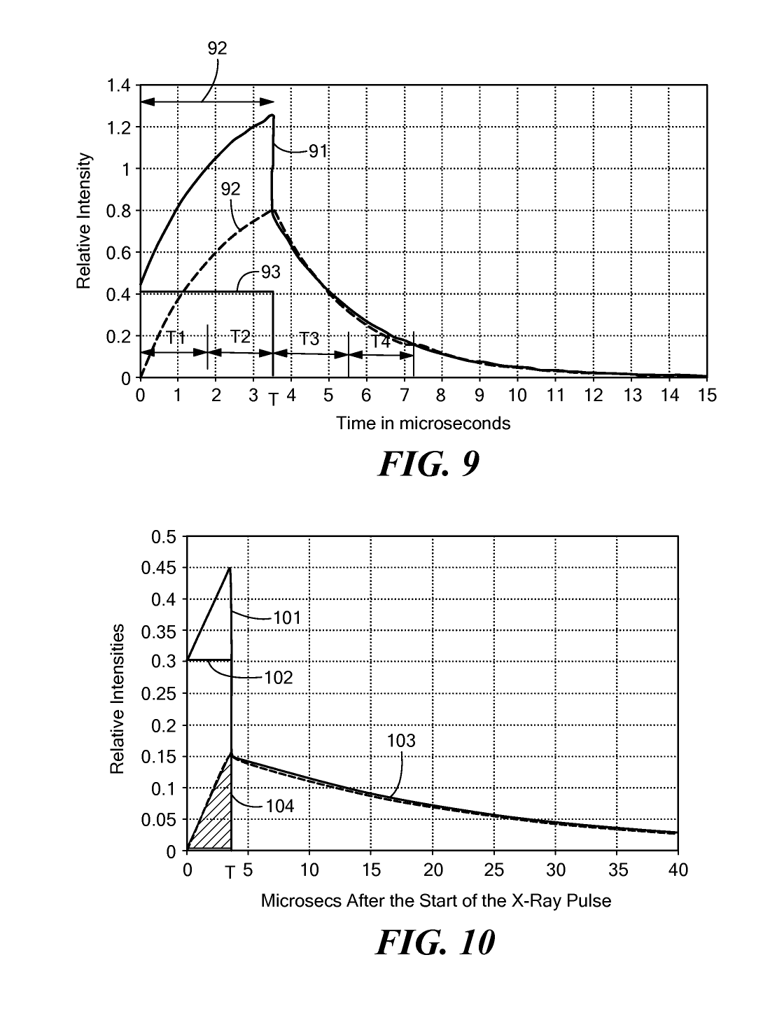

FIG. 9 shows the time dependences graphically for a beam pulse width, T, of 3.5 μs, designated by numeral 92, and a scintillator with a decay time of 1.5 μs. The latter is shorter than is desired for this invention but makes a more readily understandable illustration. The Cherenkov intensity 93 has a constant mean value; statistical fluctuations are ignored. The time-dependence of the scintillation, described by Eqs. 7a and 7b, is curve 92 of FIG. 9. The signal rises during the X-ray pulse as the scintillation intensity accumulates from new ionizations and decays from past ionizations. After time T, the scintillation light can only decay. The time-dependence of the total intensity of Cherenkov and scintillation light is shown by curve 91 of FIG. 9.

FIG. 10 shows the time structures for the case of the preferred scintillator with a decay time of 22 μs. The scintillation pulse during the 3.5 μs X-ray pulse is almost a straight rising line; only a small percentage of the scintillations decay during the X-ray pulse. The total signal strength 103 after time T represents ˜85% of the total scintillation excitations created in the time interval T. The remainder 104 can be accurately estimated, and subtracted from the signal 101 measured during the beam pulse to give a reliable measure of the Cherenkov light 102 emitted by the scintillator.

It is practical with present electronic means to make a number of intensity measurements for each beam pulse. FIG. 9 shows an example of 4 time intervals. T1 and T2 span the beam pulse itself, while T3 and T4 span the decay time after the X-ray pulse terminates. In FIG. 10, illustrating the time-dependence of a 22-μs scintillator, T1 and T2 might be 1.75 μs each, while T3 and T4 might be 22 μs each.

The described embodiments of the invention are intended to be merely exemplary and numerous variations and modifications will be apparent to those skilled in the art. All such variations and modifications are intended to be within the scope of the present invention as defined in the appended claims.

Where examples presented herein involve specific combinations of method acts or system elements, it should be understood that those acts and those elements may be combined in other ways to accomplish the same objective of X-ray inspection. Additionally, single device features may fulfill the requirements of separately recited elements of a claim. The embodiments of the invention described herein are intended to be merely exemplary; variations and modifications will be apparent to those skilled in the art. All such variations and modifications are intended to be within the scope of the present invention as defined in any appended claims.

What is claimed is:

1. A system for characterizing material composition of an object, the system comprising:
a. a source of penetrating radiation for generating a beam of penetrating radiation incident upon the object;
b. at least one detector for generating a scintillation detector signal component and a Cherenkov detector signal component based respectively upon a scintillation process and a Cherenkov radiation processes initiated by penetrating radiation that has traversed the object; and
c. a processor for deriving relative attenuation of higher and lower energy penetrating radiation in the object, disposed between the source of penetrating radiation and the at least one detector, based on the scintillation detector signal component and the Cherenkov detector signal component.

2. A system in accordance with claim 1, comprising one, and only one, detector for each pixel element.

3. A system in accordance with claim 2, further comprising a signal conditioning module of a kind that discriminates between the scintillation detector signal component and the Cherenkov detector signal component to produce a scintillation detector signal channel and a Cherenkov detector signal channel.

4. A system in accordance with claim 3, wherein the signal conditioning module is of a kind that discriminates between a scintillation detector signal component and a Cherenkov detector signal component on the basis of spectral features of the scintillation process and the Cherenkov radiation process.

5. A system in accordance with claim 3, wherein the signal conditioning module is of a kind that discriminates between a scintillation detector signal component and a Cherenkov detector signal component on the basis of temporal features of the scintillation process and the Cherenkov radiation process.

6. A detector for detecting and characterizing high energy penetrating radiation, the detector comprising:
a. a detecting medium for generating kinetic charged particles and, in response thereto, emitting electromagnetic radiation;
b. at least one photodetector for detecting electromagnetic radiation emitted by the detecting medium through a Cherenkov radiation process and through a scintillation process; and
c. a signal conditioning module, coupled to the at least one photodetector, for discriminating detector signal components due respectively to Cherenkov and scintillation processes on the basis of temporal features of the scintillation process and the Cherenkov radiation process.

7. A detector in accordance with claim 6, comprising one, and only one, photodetector.

8. A detector in accordance with claim 6, wherein the signal conditioning module is of a kind that discriminates between a scintillation component and a Cherenkov component of the detector signal on the basis of distinct respective time signatures of the scintillation component and the Cherenkov component.

9. A detector in accordance with claim 8, wherein the signal conditioning module is of a kind that distinguishes between a high temporal frequency component associated with the Cherenkov component of the detector signal and a low temporal frequency component associated with the scintillation component of the detector signal.

10. A detector in accordance with claim 8, wherein the signal conditioning module is of a kind that distinguishes between a high energy component associated with the Cherenkov component of the detector signal and a low energy component associated with the scintillation component of the detector signal.

11. A detector in accordance with claim 8, wherein the signal conditioning module is of a kind that extrapolates a temporal tail of the detector signal in response to a pulse of radiation to derive a scintillation component of the detector signal during the pulse.

12. A detector in accordance with claim 8, wherein the signal conditioning module is of a kind that subtracts a scintillation component of the detector signal during the pulse of radiation from a total measured detector signal during the pulse to derive a Cherenkov component of the detector signal during the pulse.

13. A detector in accordance with claim 6, wherein the at least one photodetector comprises:
a. a first photodetector for detecting electromagnetic radiation emitted by the detecting medium through a Cherenkov radiation process;
b. a second photodetector for detecting electromagnetic radiation emitted by the detecting medium through a scintillation process.

14. A detector in accordance with claim 6, further comprising a first photodetector signal conditioning module for receiving a first detector signal associated with the first photodetector and a second photodetector signal conditioning module for receiving a second detector signal associated with the second photodetector.

15. A detector in accordance with claim 14, wherein at least one of the first and the second signal conditioning modules includes a current-integrating electronics module.

16. A detector in accordance with claim 14, wherein the first signal conditioning module includes a gated amplifier for amplifying a signal during a specified duration of time in synchrony with emission of penetrating radiation by the source.

17. A system in for characterizing material composition of an object, in accordance with claim 1, wherein the at least one detector is in accordance with any of claims 6-16.

18. A method for deriving a material characteristic of an object intervening between a source of penetrating radiation and a detector, the method comprising:
a. detecting electromagnetic radiation emitted by a detecting medium through a Cherenkov radiation process and through a scintillation process;
b. discriminating detector signal components due respectively to Cherenkov and scintillation processes; and
c. deriving relative attenuation of higher- and lower-energy penetrating radiation in the target based on the detector signal components due respectively to Cherenkov and scintillation processes.

19. A method in accordance with claim 18, wherein time-varying spectral content of the source of penetrating radiation is employed to obtain Cherenkov and scintillation components at distinct energy levels.

20. A method in accordance with claim 18, wherein the detecting medium is a single detector.

21. A method in accordance with claim 18, wherein light measured after termination of a beam pulse provided by the source of penetrating radiation is employed to derive detector signal components due respectively to Cherenkov and scintillation processes.
